(19) United States
(12) Patent Application Publication
(10) Pub. No.: US 2026/0249556 A1
(43) Pub. Date: Aug. 27, 2026

(54) SYSTEMS AND METHODS FOR ADDITIVE MANUFACTURING

(71) Applicant: Continuous Composites Inc., Coeur d'Alene, ID (US)

(72) Inventors: Chase BOSMAN, Post Falls, ID (US); Logan Lalonde, Post Falls, ID (US); Richard Wyman, Post Falls, ID (US); Justin D. Stucki, Post Falls, ID (US); Brennon Scott Wilsey, Spokane Valley, WA (US); John K. Smith, Spokane Valley, WA (US)

(73) Assignee: Continuous Composites Inc., Coeur d'Alene, ID (US)

(21) Appl. No.: 19/541,316

(22) Filed: Feb. 16, 2026

Related U.S. Application Data
(60) Provisional application No. 63/762,816, filed on Feb. 25, 2025.

(51) Int. Cl. B29C 64/386; B33Y 10/00; B33Y 50/00; B33Y 70/10

(52) U.S. Cl. CPC B29C 64/386; B33Y 10/00; B33Y 50/00; B33Y 70/10

(57) ABSTRACT

A method of forming a composite structure with an additive manufacturing machine is disclosed. The method may include receiving or generating a virtual model representative of a post-processed version of the composite structure after fabrication by the additive manufacturing machine and after one or more geometric feature changes caused by a post-processing step performed on a corresponding pre-processed version of the composite structure fabricated by the additive manufacturing machine. The method may also include generating a tool path based on the virtual model, and causing the additive manufacturing machine to fabricate the pre-processed version of the composite structure using the tool path.

### RELATED APPLICATIONS

This application is based on and claims the benefit of priority from United States Provisional Application No. 63/762,816 that was filed on February 25, 2025, the contents of which are expressly incorporated herein by reference.

### DESCRIPTION

### TECHNICAL FIELD

The present disclosure relates generally to manufacturing systems and methods and, more particularly, to systems and methods for additive manufacturing.

### BACKGROUND

Traditional additive manufacturing is a process of creating three-dimensional parts by depositing overlapping layers of material under the guided control of a computer. A common form of additive manufacturing is known as fused deposition modeling (FDM). Using FDM, a thermoplastic material is pressed through and liquified within a heated print head. The print head is moved in a predefined trajectory (a.k.a., a tool path) as the material discharges from the print head, such that the material is laid down in a particular pattern and shape of overlapping 2-dimensional layers. The material, after exiting the print head, cools and hardens into a final form. A strength of the final form is primarily due to homogeneous properties of the particular thermoplastic material supplied to the print head and a 3-dimensional shape formed by the stack of 2-dimensional layers.

A recently developed improvement over traditional FDM manufacturing involves the use of continuous fibers embedded within material discharging from the print head. In particular, a matrix is supplied to the print head and discharged (e.g., extruded and/or pultruded) along with one or more continuous fibers also passing through the same head at the same time. The matrix can be a traditional thermoplastic matrix, a thermoset matrix (e.g., a UV-curable, thermal-curable, and/or two-part resin), a powdered metal, a metal slurry, or a combination of any of these and other known matrixes. Upon exiting the print head, a cure enhancer (e.g., a UV light, an ultrasonic emitter, a thermal source, a catalyst supply, etc.) is activated to initiate and/or complete curing of the matrix. This curing occurs almost immediately, allowing for unsupported structures to be fabricated in free space. And when fibers, particularly continuous fibers, are embedded within the structure, a strength of the structure may be multiplied beyond the matrix-dependent strength. An example of this technology is disclosed in U.S. Patent 9,511,543 that issued to Tyler on December 6, 2016 (“the ’543 patent”).

A structure that is additively manufactured from continuous fibers, while having a strength-to-weight ratio that is higher than traditionally manufactured structures, may also have strength properties that are highly dependent on the layout of the continuous fibers within the structure. That is, properties of the structure may be anisotropic. Accordingly, care should be taken to properly design the fiber layout for an intended application.

One approach to designing fiber layout within an additively manufactured structure is disclosed in U.S. Patent 9,656,429 of Mantha et al. that issued on May 23, 2017 (“the ’429 patent”). In particular, the ’429 patent discloses the steps of receiving a model for a part that is to be printed from a matrix material and a fiber material, and using the model to determine a print head tool path for use during printing. The ’429 patent further discloses the steps of generating a mesh of 3D analytic elements within the model of the part (e.g., via conventional finite element analysis – FEA), and determining a trajectory of the fiber material through each of the elements based on the tool path. The ’429 patent additionally discloses using a computer processor to determine a performance of the part based on the fiber material trajectory, making a comparison of the performance against a reference performance, and using the comparison to generate a new tool path. The process is repeated until the comparison indicates an acceptable performance of the part.

While the approach disclosed in the ’429 patent may ultimately be successful, it may be computationally complex, inaccurate, and time consuming. Specifically, it has been found that generating the mesh of 3D analytic elements disclosed in the ’429 patent is difficult to complete and often requires manual intervention by a highly skilled analyst. Thus, generating the mesh is very time consuming and often is the bottleneck of the entire design process. Errors that are introduced into the mesh generation process are propagated through and even multiplied during subsequent analysis. In addition, because the approach of the’429 patent starts with a generic tool path and applies no logic in determining a new tool path during each reiteration, it may take a significant number of iterations for the design to converge to an acceptable result.

The disclosed systems and methods are directed to overcoming one or more of the problems set forth above and/or other problems of the prior art.

### SUMMARY

In one aspect, the present disclosure is directed to a method of forming a composite structure with an additive manufacturing machine. The method may include receiving or generating a virtual model representative of a post-processed version of the composite structure after fabrication by the additive manufacturing machine and after one or more geometric feature changes caused by a post-processing step performed on a corresponding pre-processed version of the composite structure fabricated by the additive manufacturing machine. The method may also include generating a tool path based on the virtual model, and causing the additive manufacturing machine to fabricate the pre-processed version of the composite structure using the tool path.

In another aspect, the present disclosure is directed to another method of forming a composite structure with an additive manufacturing machine. This method may include receiving or generating a virtual model representative of the composite structure, slicing the virtual model into a plurality of layers, and generating a mesh of virtual elements for at least one of the plurality of layers. The method may also include generating at least one tool path for the at least one of the plurality of layers, overlaying the at least one tool path onto the mesh, assigning at least one property to the virtual elements of the mesh based on the overlaying, and analyzing an anticipated performance of the composite structure based on the assigning and the mesh. The method may further include adjusting the at least one tool path based on results of the analyzing, and causing the additive manufacturing machine to fabricate the composite structure using the at least one tool path after the adjusting.

### BRIEF DESCRIPTION OF THE DRAWINGS

FIG. 1 is a diagrammatic illustration of an exemplary disclosed additive manufacturing system;

FIG. 2 is a flowchart depicting an exemplary disclosed method that may be performed by the additive manufacturing system of FIG. 1;

FIGS. 3, 4, 5, 6, 7, and 8 are isometric illustrations of exemplary disclosed structures that may be manufactured by the additive manufacturing system of FIG. 1;

FIG. 9 is a diagrammatic illustration of an exemplary path that may be used by the system of FIG. 2 to fabricate the structures of FIGS. 3-8; and

FIG. 10 is a diagrammatic illustration of an exemplary structure broken down into layers and mesh elements that are beneficial to manufacturing utilizing the system of FIG. 2.

### DETAILED DESCRIPTION

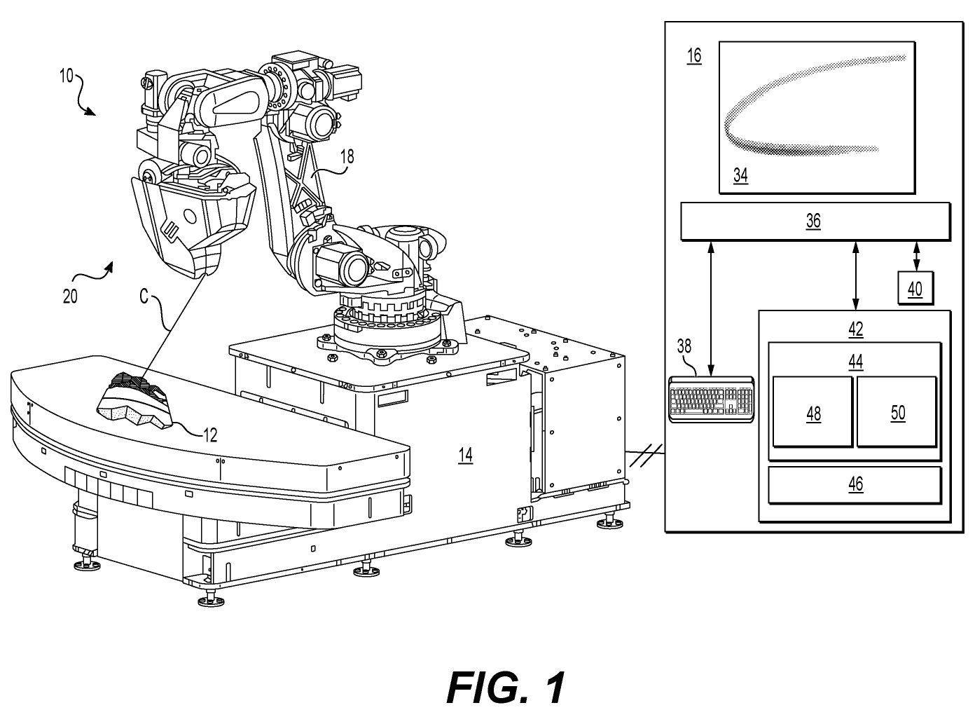

FIG. 1 illustrates an exemplary system 10, which may be used to design, plan, fabricate, and/or analyze a structure 12 having any desired shape, size, consist, and functionality. System 10 may include, among other things, an additive manufacturing machine (“machine”) 14 and at least one computing device 16 that is operatively connected to machine 14. Machine 14 may be configured to create structure 12 under the guided control of computing device 16, for example by way of an additive manufacturing process. Although additive manufacturing processes utilizing one or more continuous reinforcements (R) and one or more curable matrixes (M) will be described below as one example of how structure 12 may be created, it should be noted that other processes known in the art could alternatively be utilized for this purpose and benefit from the disclosed systems and methods.

Machine 14 may be comprised of components that are controllable to create structure 12, in 2D, 2.5D, and/or 3D (e.g., with or without the bracing of an underlying layer). These components may include, among other things, a support 18 and any number of heads 20 coupled to and powered via support 18. In the disclosed embodiment of FIG. 1, support 18 is a robotic arm capable of moving head 20 in multiple directions during fabrication of structure 12. It should be noted that any other type of support (e.g., an overhead gantry, an arm/gantry combination, etc.) capable of moving head 20 in the same or in a different manner could also be utilized, if desired. It is also contemplated that multiple supports 18 could be cooperatively controlled by computing device 16 to move any number of heads 20 during simultaneous fabrication of the same structure 12.

Each head 20 (only one shown in FIG. 1, for clarity) may be configured to discharge at least a matrix (e.g., a liquid resin, such as a zero volatile organic compound resin; a powdered metal; a metal slurry, a hardenable matrix, a curable matrix, etc.). Exemplary matrixes include thermoplastics, thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside each head 20 may be pressurized, for example by an external device (e.g., an extruder or another type of pump - not shown) that is fluidly connected to head 20 via a corresponding conduit (not shown). In another embodiment, however, the pressure may be generated completely inside of head 20 by a similar type of device. In yet other embodiments, the matrix may be gravity-fed through and/or mixed within head 20. In some instances, the matrix inside head 20 may need to be kept cool and/or dark to inhibit premature curing; while in other instances, the matrix may need to be kept warm for the same reason. In either situation, head 20 may be specially configured (e.g., insulated, temperature controlled, shielded, etc.) to provide for these needs.

In some embodiments, the matrix may be mixed with, contain, or otherwise coat one or more reinforcements (e.g., individual fibers, tows, rovings, sleeves, ribbons, and/or sheets of material) and, together with the reinforcements, make up at least a portion (e.g., a wall) of structure 12. The reinforcements may be stored within (e.g., on separate internal spools - not shown) or otherwise passed through head 20 (e.g., fed from external spools). When multiple reinforcements are simultaneously used, the reinforcements may be of the same type and have the same diameter and cross-sectional shape (e.g., circular, square, flat, etc.), or of a different type with different diameters and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous reinforcements that are at least partially encased in the matrix discharging from head 20. For the purposes of this disclosure, continuous reinforcements may be considered to have an aspect ratio (V) defined as a length (L) divided by a diameter (d) (e.g., V=L/d) that is greater than 10, 100, 1000, 100,000, 1,000,000 or even larger.

The reinforcements may be exposed to (e.g., coated with) the matrix while the reinforcements are inside head 20, while the reinforcements are being passed to head 20, and/or while the reinforcements are discharging from head 20, as desired. The matrix, dry reinforcements, and/or reinforcements that are already exposed to the matrix (e.g., wetted fibers) may be transported into head 20 in any manner apparent to one skilled in the art. The matrix, together with the reinforcements may be considered a composite material (C).

Support 18 may move head 20 in a particular trajectory (e.g., a trajectory corresponding to an intended shape, size, and/or function of structure 12) at the same time that the matrix-coated reinforcements discharge from head 20, such that continuous paths of composite material are formed along the trajectory. Each path may have any cross-sectional shape, diameter, and/or reinforcement-to-matrix ratio, and the reinforcements may be radially dispersed with the matrix, located at a general center thereof, or located only at a periphery.

One or more cure enhancers (e.g., a UV light, an ultrasonic emitter, a laser, a heater, a fan, a catalyst dispenser, etc. – not shown) may be mounted proximate (e.g., within or on) head 20 and configured to enhance a cure rate and/or quality of the matrix as it is discharged from head 20. The cure enhancer(s) may be regulated to selectively expose surfaces of structure 12 to energy (e.g., to UV light, electromagnetic radiation, vibrations, heat, air flow, a chemical catalyst or hardener, etc.) during the formation of structure 12. The energy may increase a rate of chemical reaction occurring within the matrix, sinter the matrix, harden the matrix, or otherwise cause the matrix to cure as it discharges from head 20. In some embodiments, the cure enhancer includes one or more UV lights that are distributed (e.g., equally) about and/or trailing behind a tool center point of head 20. However, it is contemplated that any number of lights, heaters, and/or other energy sources could alternatively be utilized for the disclosed purposes and/or arranged in another manner (e.g., unequally distributed, arranged in a row, etc.). The amount of energy produced by the cure enhancer may be sufficient to cure the matrix to at least hold its shape before structure 12 axially grows more than a predetermined length away from head 20. In one embodiment, structure 12 is at least partially cured before the axial growth length becomes equal to an external diameter of the matrix-coated reinforcement.

The matrix and reinforcements may be discharged from head 20 via one or more different modes of operation. In a first example mode of operation, the matrix and reinforcements are extruded (e.g., pushed under pressure and/or mechanical force) from head 20, as head 20 is moved by support 18 to create the shape of structure 12. In a second example mode of operation, at least the reinforcements are pulled from head 20, such that tensile stresses are created in the reinforcements during discharge. In some embodiments, these tensile stresses remain in the reinforcements after curing of the matrix. In the latter mode of operation, the matrix may cling to the reinforcements and thereby also be pulled from head 20 along with the reinforcements, and/or the matrix may be discharged from head 20 under pressure along with the pulled reinforcements. In the second mode of operation, where the reinforcements are being pulled from head 20, any residual tension in the reinforcements may increase a strength of structure 12, while also allowing for a greater length of unsupported material to have a straighter trajectory (i.e., the residual tension may act against the force of gravity to provide free-standing support for structure 12 and/or to resist buckling of the reinforcements).

The reinforcements may be pulled from head 20 as a result of head 20 moving away from an anchor point (e.g., a build plate or underlying layer of material). For example, at the start of structure-formation, a length of matrix-impregnated reinforcement may be pulled and/or pushed from head 20, deposited onto the anchor point, and cured, such that the discharged material adheres to the anchor point. Thereafter, head 20 may be moved away from the anchor point, and the relative movement may cause the reinforcement to be pulled from head 20. It should be noted that the movement of reinforcements through head 20 could be assisted (e.g., via internal feed mechanisms), if desired. However, the discharge rate of reinforcements from head 20 may primarily be the result of relative movement between head 20 and the anchor point, such that tension is created within the reinforcements. It is contemplated that the anchor point could be moved away from head 20 instead of, or in addition to, head 20 being moved away from the anchor point.

As will be described in more detail below, it has been determined that an axial trajectory (e.g., a vector) of each continuous reinforcement discharged by head 20 may contribute to a characteristic (e.g., a stiffness, a strength, a heat conduction, an electrical conduction, etc.) of structure 12. For example, one or more of these exemplary characteristics may be generally greater in an axial direction of each reinforcement. Accordingly, during a pre-processing (e.g., design) phase and/or processing phase of fabricating structure 12, care may be taken to provide a desired amount, size, and/or shape of particular reinforcements in alignment with particular trajectories prior to and/or during curing, such that structure 12 performs according to required specifications.

Any number of separate computing devices 16 may be used to design and/or control the placement and residual tension of reinforcements within structure 12 and/or to analyze performance characteristics (e.g., stiffness, strength, heat conduction, electrical conduction, print time, material usage, and/or other characteristics) of structure 12 before and/or after formation. Computing device 16 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 16 may include a liquid crystal display (LCD), a light emitting diode (LED) screen, an organic light emitting diode (OLED) screen, and/or another known display device. Display 34 may be used for presentation of data (e.g., performance of structure 12) under the control of processor 36.

Processor 36 may be a single or multi-core processor configured with virtual processing technologies, and use logic to simultaneously execute and control any number of operations. Processor 36 may be configured to implement virtual machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as analysis and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system - not shown) that is in direct communication with computing device 16, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 16 is communicatively connected to one or more remote memory devices (e.g., remote databases - not shown) through a network (not shown). The remote memory devices can be configured to store information that computing device 16 can access and/or manage. By way of example, the remote memory devices could be document management systems, Microsoft SQL database, SharePoint databases, Oracle™ databases, Sybase™ databases, Cassandra, HBase, or other relational or non-relational databases or regular files. Systems and methods consistent with disclosed embodiments, however, are not limited to separate databases or even to the use of a database.

Programs 44 may include one or more software or firmware modules causing processor 36 to perform one or more functions of the disclosed embodiments. Moreover, processor 36 can execute one or more programs located remotely from computing device 16. For example, computing device 16 can access one or more remote programs that, when executed, perform functions related to disclosed embodiments. In some embodiments, programs 44 stored in memory 42 and executed by processor 36 can include one or more of design, fabrication, and/or analysis apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows™, Unix™, Linux™, OSX™, and IOS™ operating systems, Android™ operating systems, or another type of operating system 50. Accordingly, disclosed embodiments can operate and function with computer systems running any type of operating system 50.

I/O devices 38 may include one or more interfaces for receiving signals or input from a user and/or machine 14, and for providing signals or output to machine 14 that allow structure 12 to be printed. For example, computing device 16 can include interface components for interfacing with one or more input devices, such as one or more keyboards, mouse devices, and the like, which enable computing device 16 to receive input from a user.

Peripheral device(s) 40 may be standalone devices or devices that are embedded within or otherwise associated with machine 14 and used during fabrication of structure 12. Peripherals 40 can embody input devices (e.g., one or more sensors, such as tension sensors, position sensors, pressure sensors, temperature sensors, flow sensors, continuity sensors, humidity sensors, rotary encoders, and other sensors known in the art) and/or output devices (e.g., one or more actuators, such as a matrix supply, a reinforcement supply, a cooling device, a pump, cure enhancers 22, a positioning motor, a cutter, a splicer, a weaving mechanism, a reinforcement guide, a mixer, a feed roller, a tensioner, etc.). In some embodiments, peripherals 40 may, themselves, include one or more processors, a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, etc., including capture commands, processing commands, motion commands, and/or transmission commands. The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design, fabrication, and/or analysis apps 48 may cause computing device 16 to perform methods related to generating, receiving, processing, analyzing, storing, and/or transmitting data in association with operation of machine 14 and corresponding design/fabrication/analysis of structure 12. For example, apps 48 may be able to configure computing device 16 to perform operations including: showing a graphical user interface (GUI) on display 34 for receiving design/control instructions and information from the operator of machine 14; capturing sensory data associated with machine 14 (e.g., via peripherals 40); receiving instructions via I/O devices 38 and/or the user interface regarding specifications, desired characteristics, and/or desired performance of structure 12; processing the control instructions; generating one or more possible designs of and/or plans for fabricating structure 12; analyzing and/or optimizing the designs and/or plans; providing recommendations of one or more designs and/or plans; controlling machine 14 to fabricate a recommended and/or selected design via a recommended and/or selected plan; analyzing the fabrication; and/or providing feedback and adjustments to machine 14 for improving future fabrications.

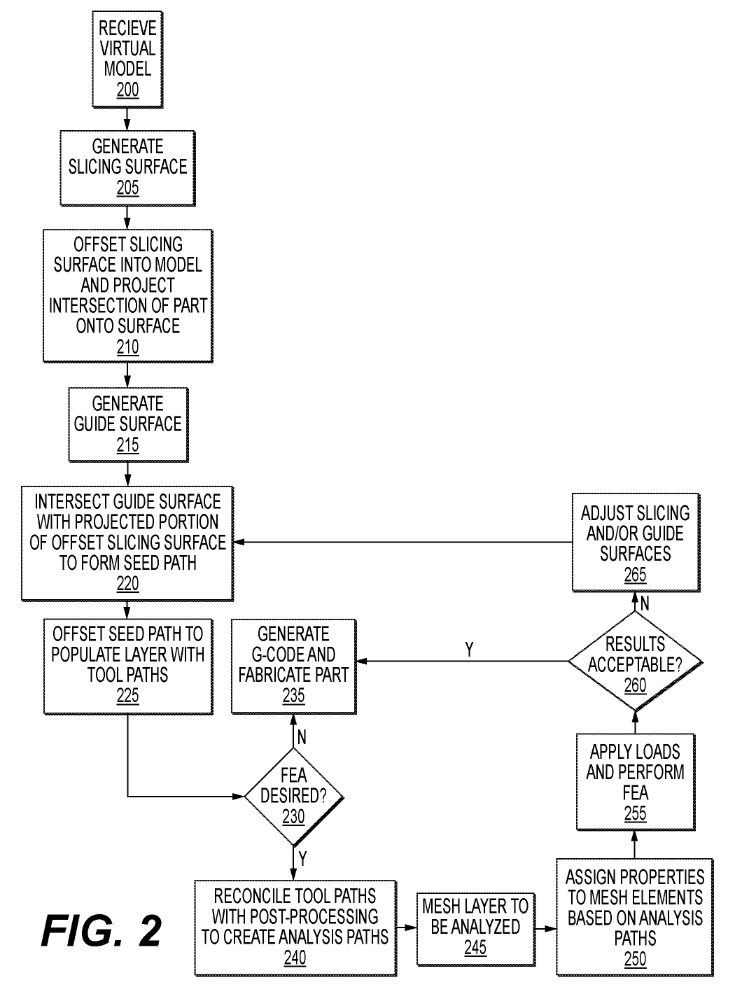

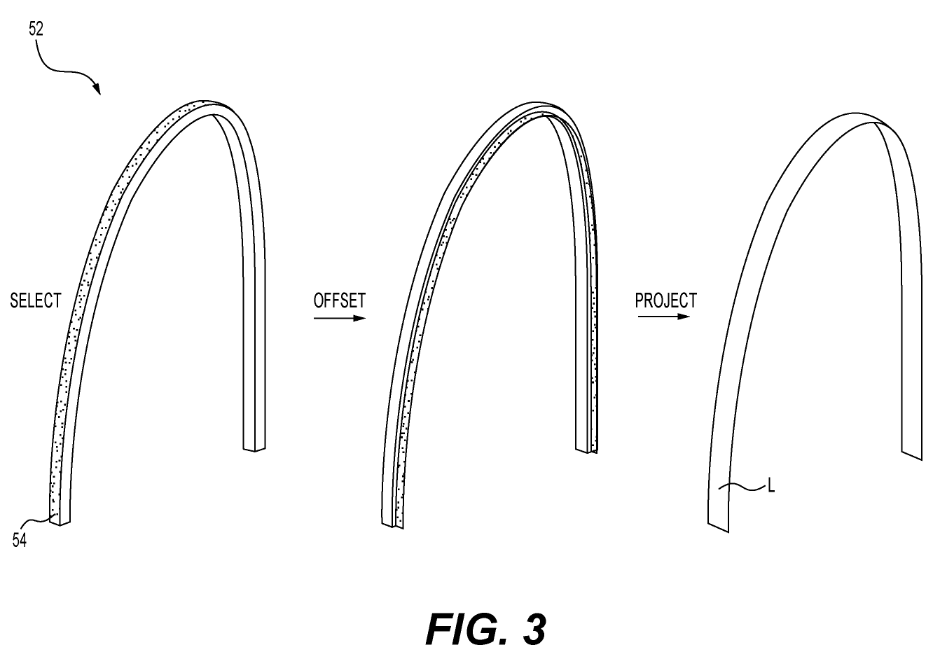

FIG. 2 is a flowchart depicting an exemplary method that may be implemented by computing device 16 during design, fabrication, and/or analysis of structure 12 by machine 14. FIGS. 3-10 represent various steps in the method of FIG. 2. FIGS. 2-10 will be discussed in detail in the following section to further illustrate the disclosed concepts.

### Industrial Applicability

The disclosed systems may be used to continuously manufacture composite structures having any desired cross-sectional shape, length, density, stiffness, strength, and/or other characteristic. The composite structures may include any number of different reinforcements of the same or different types, diameters, shapes, configurations, and consists, and/or any number of different matrixes. Operation of system 10 will now be described in detail, with reference to FIGS. 2-10.

As can be seen in the flowchart of FIG. 2, the creation of structure 12 may generally begin by receiving into system 10 information associated with structure 12 (Step 200). This information may include, among other things, a virtual model 52 (e.g., a 1D, 2D or 3D model - shown in FIG. 3) of structure 12. Model 52 may be received as a collection of data that is interpretable by processor 36 using programs 44 (e.g., app 48), the data defining physical attributes (e.g., shape, size, orientation, etc.) of structure 12. Model 52 may be received by way of I/O devices 38 (referring to FIG. 1) or a network connection (e.g., from a conventional CAD module), retrieved by processor 36 from memory 42, and/or generated and modified by processor 36 and/or a user via programs 44. In the example of FIGS. 1 and 3, model 52 represents an airfoil of structure 12, at least a portion of which is to be fabricated by system 10.

During and/or after completion of Step 200, processor 36 may be configured to generate a slicing surface 54 (Step 205). Slicing surface 54 may be a 2D or 3D, zero-thickness, virtual element located at a boundary of model 52, inside of model 52, and/or outside of model 52. It is contemplated that slicing surface 54 could be open (e.g., not enclosing a volume), closed (e.g., completely enclosing a volume), or partially closed (e.g., tubular, cylindrical, conical, cubical, etc. that forms a volume having one or more open ends).

Slicing surface 54 may be selected by a user, defined by the user, automatically selected by processor 36, and/or automatically defined by processor 36. In one example, slicing surface 54 may embody or mirror an exposed surface of a mold (e.g., a build plate) on which head 16 is to deposit material. In another example, slicing surface 54 may embody or mirror an outer surface (e.g., a geometrically most-complex outer surface) of structure 12 that is or is not resting on the mold. In yet another example, slicing surface 54 may pass through a portion of model 52, with or without any mirroring of an existing surface. In still another example, slicing surface 54 may be a compound surface made up of multiple existing surfaces and/or user-generated or user-defined surfaces. In a final example, slicing surface 54 may be automatically generated based on anticipated loading of structure 12 (e.g., to generally align with a vector field passing through structure 12). Other ways of selecting, generating, defining, and/or placing slicing surface 54 are also envisioned.

In the example of FIG. 3, an existing outer surface of model 52 has been selected by the user as slicing surface 54. As can be seen in both FIGS. 2 and 3, the next step in generating tool paths for structure 12 may be to offset slicing surface 54 into model 52 and to project boundaries of the model 52 associated with the offset depth onto slicing surface 54 (Step 210). The amount of offset may be defined by the user and/or automatically determined by processor 36. In one example, slicing surface 54 is offset into model 52 by a desired thickness that is to be fabricated as a distinct layer L. In another example, slicing surface 54 is offset into model 52 by an amount greater than the thickness of a single layer (e.g., toward, at, or near a depth-wise midlayer of model 52 – see FIG. 3). Any number of distinct layers L may be created by repeating Step 210 and using a different (e.g., incremental) offset distance. In one example, Step 210 is repeated until model 52 is sliced (e.g., partitioned, divided, etc.) into adjacent and overlapping layers L that completely fill a volume of model 52. It is contemplated that a thickness of each resulting layer L may be the same or different, as desired. It is also contemplated that the thickness of a given layer L may be variable, for example based on a distance between toolpath centerlines and/or an amount of consolidation during material discharge.

The boundaries projected onto slicing surface 54 during layer propagation may correspond with existing outer surfaces of model 52 or other surfaces selected and/or defined by the user or processor 36. These boundaries, once projected onto slicing surface 54, may function to laterally limit each resulting layer L to an area that should subsequently be populated with tool paths. Without this projection, it might otherwise be possible for processor 36 to inadvertently generate tool paths that extend beyond edges of model 52.

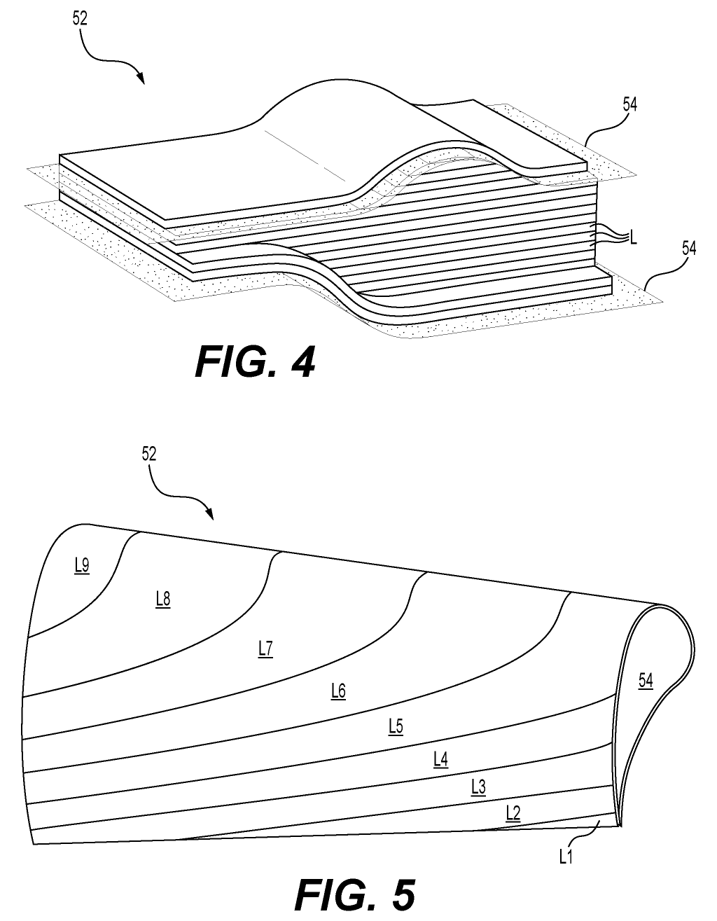

It should be noted that multiple slicing surfaces 54 may be generated at Step 205 and used to cooperatively determine layering of model 52, if desired. In these instances, surfaces 54 may be offset from different sides of model 52 (see FIG. 4) into model 52 (a.k.a., contractive slicing) and/or in different (e.g., opposing) directions from a same general location (a.k.a., expansive slicing) within model 52. It should be noted that when slicing surface 54 is a closed or partially closed element, contractive and expansive slicing may be possible with a single slicing surface 54. For example, such a surface may be radially offset in an inward direction for contractive slicing and/or in an outward direction (See FIG. 5) for expansive slicing.

One or more guide surfaces 56 may be generated for use in creating tool paths within each layer L (Step 215). Each guide surface 56 may be a 2D or 3D, zero-thickness, virtual element placed to intersect any number of layers L of model 52. Like slicing surfaces 54 described above, guide surfaces 56 may be selected by a user, defined by the user, automatically selected by processor 36, and/or automatically defined by processor 36.

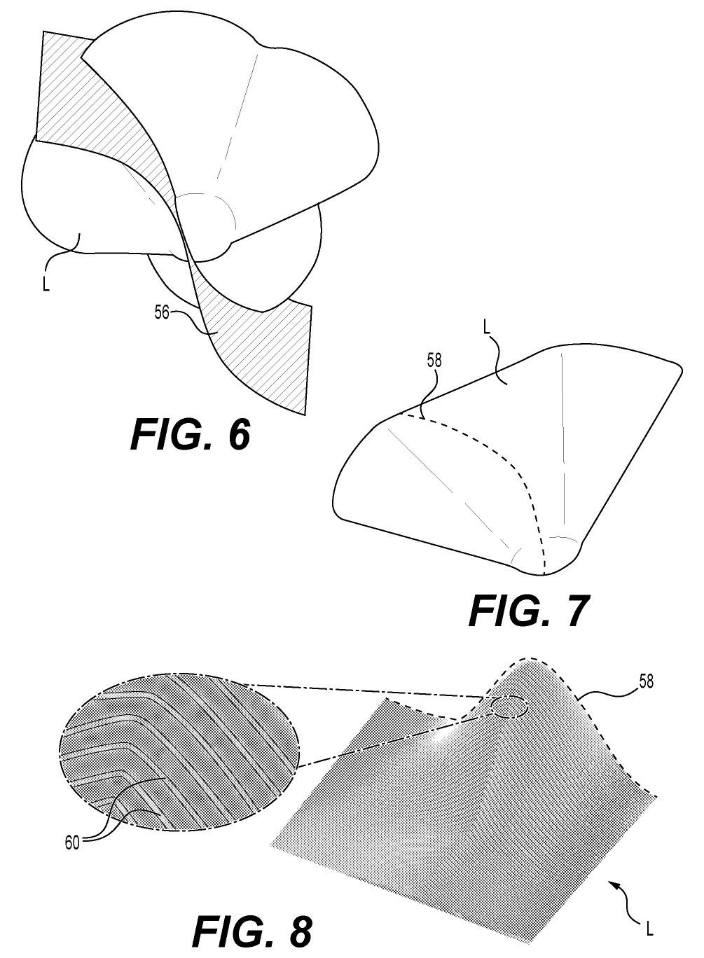

As shown in FIGS. 6, 7, and 8, guide surface 56 may be caused to intersect with a given layer L (Step 220) and form a line (e.g., 2D or 3D line) that functions as a seed path 58 for that layer L. Seed path 58 may then be offset within the layer L to generate an adjacent tool path within the layer L (Step 225). The amount of offset, centerline-to-centerline, of the tool paths may about equal to a diameter of the composite material (e.g., of the reinforcement) discharging from head 16 (e.g., as the material exits a nozzle and/or as the material is consolidated by a compactor), such that tows of the material can be deposited next to each other with minimal overlapping or gapping. The offset may be in a single direction away from seed path 58 within a layer L or in opposing directions, as desired. When multiple guide surfaces 56 intersect a given layer L and create multiple seed paths 58, tool paths may be generated between the seed paths 58 via interpolation. In some embodiments, one or more of the seed paths 58 may be weighted, such that the interpolation is affected more by a particular seed path 58 based on the weighting.

The method of FIG. 2 may continue differently depending on whether analysis of the generated tool paths is desired (Step 230). When analysis is not desired, (Step 230:N), control may proceed to Step 235 where code is generated for controlling machine 14 to fabricate structure 12 utilizing the tool paths generated at Step 225.

When it is determined at Step 230 that analysis (e.g., Finite Element Analysis – FEA) is desired (Step 230:Y), control may progress to Step 240 instead of directly to Step 235. To comprehensively analyze an anticipated performance of structure 12, processing occurring after fabrication of structure 12 by machine 14 should be accounted for. That is, some processes (e.g., subtraction processes; pyrolization processes; densification processes; and other processes known in the art) can result in reinforcements being severed, cracked, separated, removed, or otherwise weakened. If analysis was performed utilizing the tool paths only as-generated at Step 225, the analysis could show an artificially inflated performance. Accordingly, in order to improve accuracy of the analysis, the tool paths generated at Step 225 may be reconciled at Step 240 with the anticipated effects of any intended post-processing. In one example, this may include clipping, dividing, separating, and/or removing one or more of tool paths from one or more layers of structure 12 to create a related set of tool paths (a.k.a., analysis paths) that can be used for analysis of structure 12. It should be noted that the analysis paths would generally not be used to fabricate structure 12.

Following reconciliation of the tool paths to create analysis paths, processor 36 may generate a mesh (e.g., a 2D mesh) of interconnected geometrical shapes for one or more layers to be analyzed (Step 245). In some embodiments, processor 36 may receive input from the user regarding desired edits to the mesh. These edits may include, for example, a type and/or sizes of the geometrical shapes used in the mesh, boundary locations of particular shapes, densities of the shapes at particular locations, etc.

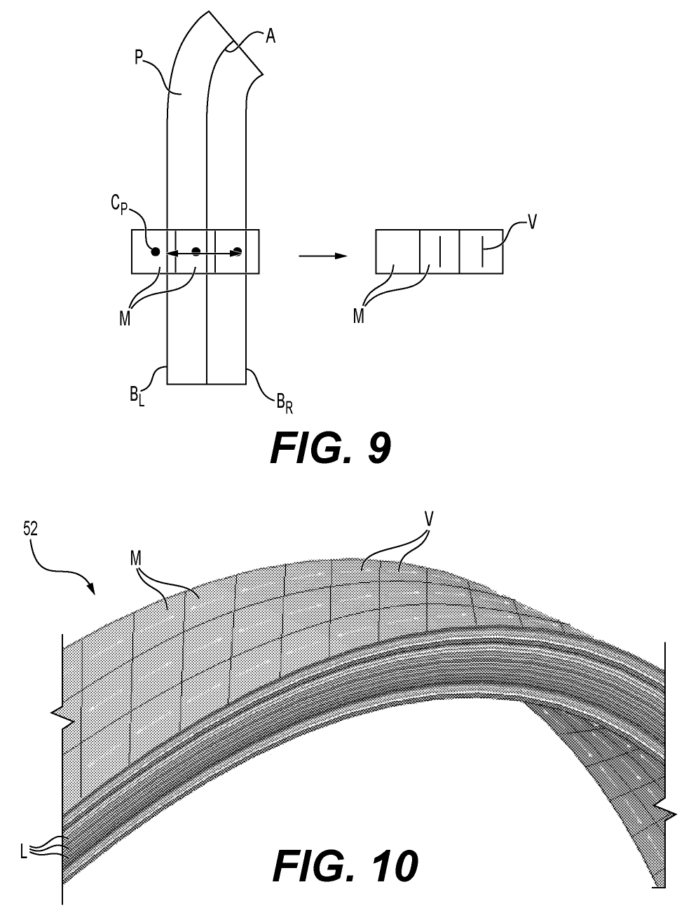

When the mesh for a particular layer is complete and acceptable to the user, processor 36 may assign properties to each element of the mesh (Step 250). In one example, these properties may be assigned based on a material of the reinforcement and/or matrix and a trajectory of an associated path along which the material will be discharged. For instance, the analysis paths described above may be overlaid on the mesh for a corresponding layer, and processor 36 may then compare a centerpoint location of each element in the mesh to transverse boundaries (e.g., boundaries located radially, such as to the left and right, of a center axis) of an overlying path. As shown in FIG. 9, when the centerpoint Cp of a given mesh element M is located between the transverse boundaries B L, B R, a vector V tangential to a center axis A of the analysis path P is assigned by processor 36 to that mesh element. Similarly, material properties associated with that analysis path are assigned to that mesh element.

In the example of FIG. 9, a single analysis path is shown overlying three adjacent and rectangularly shaped mesh elements. The centerpoint of the left-most element is not located between the transverse boundaries of the analysis path and, accordingly, is not assigned a vector or material properties corresponding to the analysis path shown. However, the centerpoints of the remaining two rectangles are located between the transverse boundaries and, therefore, assigned corresponding tangential vectors and material properties.

Once all elements of the mesh of all layers have been assigned vectors (see FIG. 10) and material properties, anticipated loads may be applied to the mesh and processor 36 may perform FEA (Step 255) according to parameters set by the user. The loads may include, among other things, compression loads, tension loads, bending loads, torsion loads, thermal loads, environmental loads, and boundary conditions (e.g., constrained connections to other components). The loads may be received via I/O device(s) 38 in any manner known in the art. For example, they may be received via manual touching of display 34 or mouse-clicking at corresponding locations of model 52, and by drawing or otherwise entering directions, magnitudes, and boundary conditions (e.g., constraint types and coordinates). In another example, the loads and/or boundary conditions may be automatically generated based on a known weight of the associated structure, known operating parameters, known environmental conditions, etc. In yet another embodiment, the loads and/or boundary conditions may be imported as one or more electronic files.

FEA may be completed on a layer-by-layer basis, after which a global performance of structure 12 may be determined. This may be achieved, for example, by summing the performance of the individual layers. Care should also be taken to account for interlaminar effects between the layers.

After FEA has been completed, results of the analysis may then be rendered on display 34 for the user to observe. The user may thereafter determine if the results are acceptable (Step 260). When the results are acceptable (Step 260:Y), control may advance from Step 260 to Step 235. As mentioned above, in most instances, the tool paths (i.e., not the analysis paths) may be converted to code at Step 235 and used to control operations of machine 14. However, it is contemplated that, in other instances, the analysis paths may be used for this purpose, if desired.

When the FEA results are not acceptable (Step 260:N), adjustments may be made by the user to try and improve the results (Step 265). These adjustments may include, among other things, adjustments (e.g., location adjustments, orientation adjustments, shape adjustments, and/or other adjustments) made to the slicing surface and/or guide surface. Any adjustments made to the slicing surface and/or guide surface will result in different tool paths and corresponding analysis paths. It is contemplated that adjustments could also be made to tuning parameters (e.g., offset distance, trajectory angle, etc.), if desired. Control may cycle back to Step 220 and continue to cycle from Steps 220-265 until results become acceptable to the user.

In some embodiments, it may be possible for a first tool path to intersect a second tool path. In this scenario, the first tool path may be divided into two segments that extend at either side of the second tool path in opposing directions. Subsequently, during analysis of this intersection, each segment of the first tool path and the second tool path may be analyzed separately using the processes described above, and analysis results for the multiple tool paths may be summed to determine an anticipated performance of the given layer.

It should be noted that, while the above process has been described as having a particular sequence of particular steps, some of the steps may be omitted, steps may be added, and the sequence of steps may be adjusted for particular applications.

It will be apparent to those skilled in the art that various modifications and variations can be made to the disclosed systems and methods. Other embodiments will be apparent to those skilled in the art from consideration of the specification and practice of the disclosed systems and methods. For example, while Step 243 is explicitly called out as part of the analysis and tool-pathing process, accounting for post-processing could be handled differently, if desired. In an alternative embodiment, the mesh created at Step 245 could be generated based on a model of structure 12 that already includes feature changes caused by the anticipated post-processing (i.e., based on a post-processed model). In this embodiment, one or more mesh elements associated with a post-processed surface may be omitted, leaving less or fewer surfaces that require tool-pathing. Accordingly, the post-processed model would be used to create a tool path for an unfinished or pre-processed version of structure 12 (i.e., a version that does not have the feature changes caused by the post-processing). Also, while the disclosed processes are described as surface-centric (i.e., that the toolpaths are derived off of guide surfaces), it should be noted that the toolpaths could just as likely be derived from a guide volume, a guide curve, a guideline, a guide vector field, etc. It is intended that the specification and examples be considered as exemplary only, with a true scope being indicated by the following claims and their equivalents.

What is claimed is:

1. A method of fabricating a composite structure with an additive manufacturing machine, comprising:
receiving or generating a virtual model representative of a post-processed version of the composite structure after fabrication by the additive manufacturing machine and after one or more geometric feature changes caused by a post-processing step performed on a corresponding pre-processed version of the composite structure fabricated by the additive manufacturing machine;
generating a tool path based on the virtual model; and
causing the additive manufacturing machine to fabricate the pre-processed version of the composite structure using the tool path.

2. The method of claim 1, further including:
analyzing an anticipated performance of the composite structure based on the generated tool path; and
adjusting the generated tool path based on the analyzing,
wherein causing the additive manufacturing machine to fabricate the pre-processed version of the composite structure using the generated tool path includes causing the additive manufacturing machine to fabricate the pre-processed version of the composite structure using the generated tool path after the adjusting.

3. The method of claim 2, wherein the post-processing step is a subtractive process.

4. The method of claim 2, wherein analyzing the anticipated performance includes:
slicing the virtual model into a plurality of layers;
generating a mesh of virtual elements for at least one of the plurality of layers;
overlaying the generated tool path onto the mesh;
assigning at least one property to the virtual elements of the mesh based on the overlaying; and
analyzing the anticipated performance based on the assigning and the mesh.

5. The method of claim 4, wherein the mesh is a 2D mesh.

6. The method of claim 4, wherein slicing the virtual model includes offsetting at least one slicing geometry through the virtual model.

7. The method of claim 6, wherein the at least one slicing geometry is a closed or partially closed surface.

8. The method of claim 6, wherein offsetting the at least one slicing geometry includes radially expanding or contracting the closed or partially closed surface.

9. The method of claim 6, wherein:
the at least one slicing geometry includes two slicing surfaces that are spaced apart from each other; and
offsetting includes offsetting the two slicing surfaces towards each other.

10. The method of claim 9, further including interpolating between the two slicing surfaces to slice the virtual model into layers between the two slicing surfaces.

11. The method of claim 6, wherein:
the at least one slicing geometry is an outer surface identified as having a greatest geometric complexity within the virtual model; and
offsetting the at least one slicing geometry includes offsetting the outer surface to a point partway through the virtual model.

12. The method of claim 1, wherein the post-processing step is a subtractive step to be performed by a machine different from the additive manufacturing machine.

13. The method of claim 4, wherein analyzing the anticipated performance includes performing finite element analysis.

14. The method of claim 4, wherein assigning properties to the virtual elements includes assigning to a given element a property vector that is tangential to a center axis of the tool path when a centerpoint of the given element is located between transverse boundaries of the tool path.

15. The method of claim 4, wherein, when the generated tool path is a first tool path that intersects a second tool path within a given layer:
the first tool path is separated into multiple segments within the given layer;
each of the multiple segments is separately analyzed; and
analysis results for the multiple segments of the first tool path and for the second tool path are summed to determine a performance of the given layer.

16. The method of claim 4, wherein adjusting the generated tool path includes adjusting a guide surface used to generate the tool path within a given layer of the virtual model.

17. A method of fabricating a composite structure with an additive manufacturing machine, comprising:
receiving or generating a virtual model representative of the composite structure;
slicing the virtual model into a plurality of layers;
generating a mesh of virtual elements for at least one of the plurality of layers;
generating at least one tool path for the at least one of the plurality of layers;
overlaying the at least one tool path onto the mesh;
assigning at least one property to the virtual elements of the mesh based on the overlaying;
analyzing an anticipated performance of the composite structure based on the assigning and the mesh;
adjusting the at least one tool path based on results of the analyzing; and
causing the additive manufacturing machine to fabricate the composite structure using the at least one tool path after the adjusting.

18. The method of claim 17, wherein:
the virtual elements of the mesh are 2D elements; and
assigning at least one property to the virtual elements includes assigning to a given one of the 2D elements a property vector that is tangential to a center axis of the at least one tool path when a centerpoint of the given one of the 2D elements is located between transverse boundaries of the at least one tool path.

19. The method of claim 17, wherein, when the at least one tool path intersects with another tool path within a given layer:
the at least one tool path is separated into multiple segments within the given layer;
each of the multiple segments of the at least one tool path and the other tool path are separately analyzed; and
analysis results for the multiple segments and the other tool path are summed to determine a performance of the given layer.

20. The method of claim 17, wherein adjusting the at least one tool path includes adjusting a guide surface used to generate the at least one tool path within a given layer of the virtual model.
